(19) United States
(12) Patent Application Publication
(10) Pub. No.: US 2009/0088190 A1
(43) Pub. Date: Apr. 2, 2009

(54) Mbms Soft Combining Scheme

(76) Inventors: Xinhua Wang, Victoria (AU); Thanh Ngoc Bui, Victoria (AU); Dobrica Vasic, Victoria (AU)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/922,481

(22) PCT Filed: Jun. 23, 2006
(86) PCT No.: PCT/JP2006/313031

§ 371 Date: Dec. 19, 2007

(30) Foreign Application Priority Data
Jun. 23, 2005 (AU) 2005903315
May 19, 2006 (AU) 2006202144

(51) Int. Cl. H04W 4/12

(52) U.S. Cl. 455/466

(57) ABSTRACT

A method (200) of conducting soft combining of at least two MBMS signals in a user equipment (112) of a radio telecommunications network (100), the method including demodulating at least a subset of the received signals (202); and soft combining at least a MBMS data field from two or more of the demodulated signals into a single MBMS data field prior to de-interleaving the MBMS data fields (208).

### TECHNICAL FIELD

The present invention relates to methods for performing soft combining in a user equipment of a UTRA network that is receiving a multimedia broadcast multicast service (MBMS).

### BACKGROUND ART

Most traditional telecommunications services are essentially point-to-point in nature, that is, such services involve communication between a single originating device and a single receiving device. Examples of such point-to-point services include traditional telephone and many on-demand content delivery services such as data downloading, on-demand data streaming.

In recent times, however it has become apparent that broadcast services, or point-to-multipoint services, are attractive to both service providers and customers. For instance customers may be happy to receive some information, e.g. news bulletins and weather reports via a broadcast service. For network providers, broadcast services offer the ability to more efficiently use network resources to send information to a plurality of users compared to servicing the same number of users using point-to-point services.

One point-to-multipoint service that has been developed is the MBMS which has recently been standardised by the 3^{rd} Generation Partnership Project (3GPP) in 3GPP TS 25.346. In release 6 of this and other related standards, the ability for the user equipment to conduct soft combining of a plurality of MBMS signals from neighbouring cells is mandated. However no specific method for soft combining is mandated in this standard.

The applicant's co-pending Australian complete patent application, filed on the same day as the present application, and entitled “MBMS soft combining” (the contents of which are incorporated herein by reference) offers one method of performing soft combining of MBMS signals.

Accordingly there is a need for additional methods for use in performing soft combining in a user equipment that is receiving a multimedia broadcast multicast service.

### DISCLOSURE OF INVENTION

The present inventors have determined that soft combining can be performed at a range of stages after the separation of the transport format combination indicator and data field symbols but before channel decoding. In a particularly preferred embodiment, the present inventors have determined that soft combining can advantageously be performed after the separation of TFCI data field symbols and before the second de-interleaving.

In a first aspect there is provided a method of conducting soft combining of at least two MBMS signals in a user equipment of a radio telecommunications network, the method including:

demodulating at least a subset of the received signals, and

soft combining at least a MBMS data field from two or more of the demodulated signals into a single MBMS data field prior to de-interleaving process the MBMS data fields.

The method preferably includes a preliminary step of, extracting transport format data from one or more of the demodulated received signals.

Preferably the method includes processing transport format data extracted from a plurality of the demodulated received signals to generate transport format data for use in subsequent processing of the soft combined MBMS data.

Processing the transport format data extracted from each of a plurality of the demodulated received signals can include: decoding a transport format data set for a plurality of the demodulated received signals; and, generating a respective transport format decoding status data for each transport format data set.

The method can include selecting transport format data obtained from one or more of the demodulated received signals at least partly on the basis of the signal's respective transport format decoding status data, for use in further processing of the soft combined MBMS data.

The method can alternatively include generating a transport format data set for use in further processing of the soft combined MBMS data using a majority voting scheme. In this case the method can include biasing the majority voting scheme such that in the event that no majority exists, a transport format data set can be obtained. Alternatively, in the event that no majority exists, the transport format data set can be selected randomly from the decoded ones available.

It should be noted that each of the received MBMS signals can include one or more signals received from corresponding nodes of the radio telecommunications network that form part of a transmission cluster, configured to transmit MBMS data in a given time period.

In a second aspect the present invention provides a method of receiving an MBMS service in a user equipment of a radio telecommunications network, the method including soft combining of at least two MBMS signals substantially in accordance with the first aspect of the invention or independently.

In a further aspect the present invention also provides a user equipment configured to soft combine at least two MBMS signals substantially in accordance with the first aspect of the invention.

### BRIEF DESCRIPTION OF DRAWINGS

Illustrative embodiments of the present invention will now be described by way of non-limiting example only with reference to the accompanying drawings, in which:

FIG. 1 depicts a user equipment receiving an MBMS service from a plurality of transmission clusters in a UTRA network;

FIG. 2 is a flow chart depicting the steps in a method of soft combining according to an embodiment of the present invention;

FIG. 3 depicts the principle of transport format signal combining used in a further embodiment of the present invention, and

FIG. 4 depicts a method by which TFCI decoding status may be obtained in an embodiment of the present invention

### BEST MODE FOR CARRYING OUT THE INVENTION

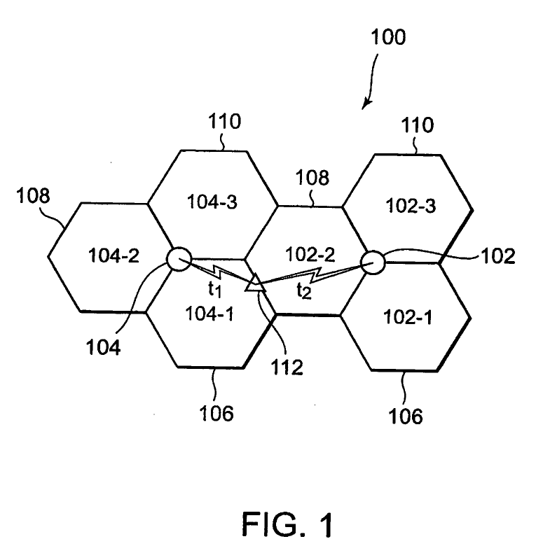

FIG. 1 depicts a portion of a UTRA network 100 which includes two nodes 102 and 104. Each node 102 and 104 include 3 sector transmitters e.g. 102-1, 102-2 and 102-3 belonging to node 102 and 104-1, 104-2 and 104-3 belonging to node 104.

In the present embodiment corresponding sectors of the two nodes 102 and 104 are grouped into transmission clusters. A first cluster 106 includes transmission sectors 102-1 and 104-1, the second transmission cluster 108 includes transmission sectors 102-2 and 104-2 and a third transmission cluster 110 includes transmission sectors 102-3 and 104-3.

In transmitting an MBMS service each transmission cluster is allocated a particular time slot for MBMS data transmission. As will be appreciated by those skilled in the art, the time slots assigned to a specific service among the clusters are typically not time-aligned. Accordingly, a user equipment operating in the network 100 will receive the same MBMS transmission from different transmission clusters over one or more time slots with different relative delays.

In the present example, a single user equipment 112 is depicted. The user equipment 112 receives MBMS transmissions from both nodes 102 and 104. In a first time slot t₁ the user equipment 112 receives the MBMS transmission from the transmission cluster 106 and in a second time slot t2 the user equipment 112 receives the same MBMS data from the cluster 108 The user equipment 112 may also receive a third transmission of the MBMS data in a time slot t3. However, in the present example, as the user equipment does not fall within the transmission area of a sector of the transmitter belonging to the cluster 110, no third transmission is received.

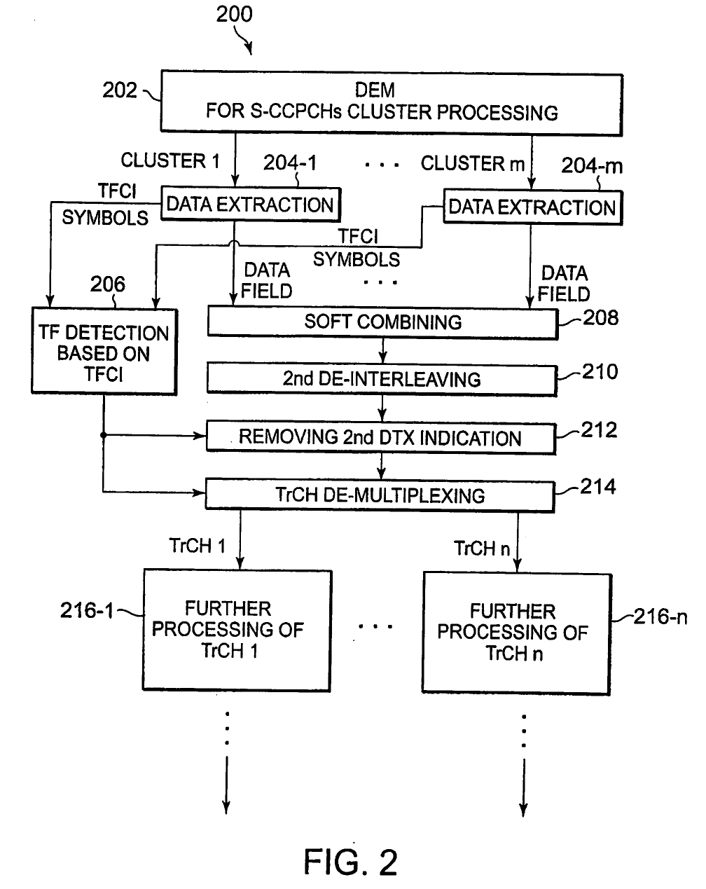

In order to obtain the reliability benefits associated with receiving multiple versions of the same MBMS data, the user equipment 112 is arranged to combine the signals or select the best of these signals for provision of the MBMS service to the user. FIG. 2 depicts a flow chart in a so called soft combining scheme that can be used by the user equipment.

In FIG. 2 the method 200 begins by receiving MBMS signals of a plurality of transmission clusters. The method 200 starts with demodulating the received signal in step 202 to extract Secondary Common Control Physical Channel (S-CCPCH) signals corresponding to each cluster. For each cluster, that is cluster 1 to cluster m, transport format information is extracted at steps 204-1 to 204-m. The transport format information is used in step 206 to determine the transport format of the received data for use in steps 212 for removing the 2nd DTX indicators and 214 (to be described below) for de-multiplexing the n transport channels from received signals.

In the next step 208 the remaining MBMS data fields from each cluster, i.e. clusters 1 to m undergo a soft combining process. The soft combining process is performed on a slot-by-slot basis. In this embodiment the required buffer size for soft combining is proportional to the maximum time difference between corresponding points in the MBMS data received from each the S-CCPCH transmission cluster, rounded up to an integer number of slots. The soft combining step can be performed in any suitable manner, including, but not limited to, the methods described in the applicant's co-pending Australian provisional patent application mentioned above.

Once soft combining is performed a single second de-interleaving process 210 can be undertaken in the conventional manner, followed by the removal of the second discontinuous transmission indication in step 212. In the next two steps 212 for the removal of the second discontinuous transmission indication and 214 for transport channel de-multiplexing are undertaken on the basis of the transport format information extracted in step 206. Further processing of each of the transport channels, i.e. transport channels 1 to n, are undertaken at steps 216-1 and 216-n in the usual manner.

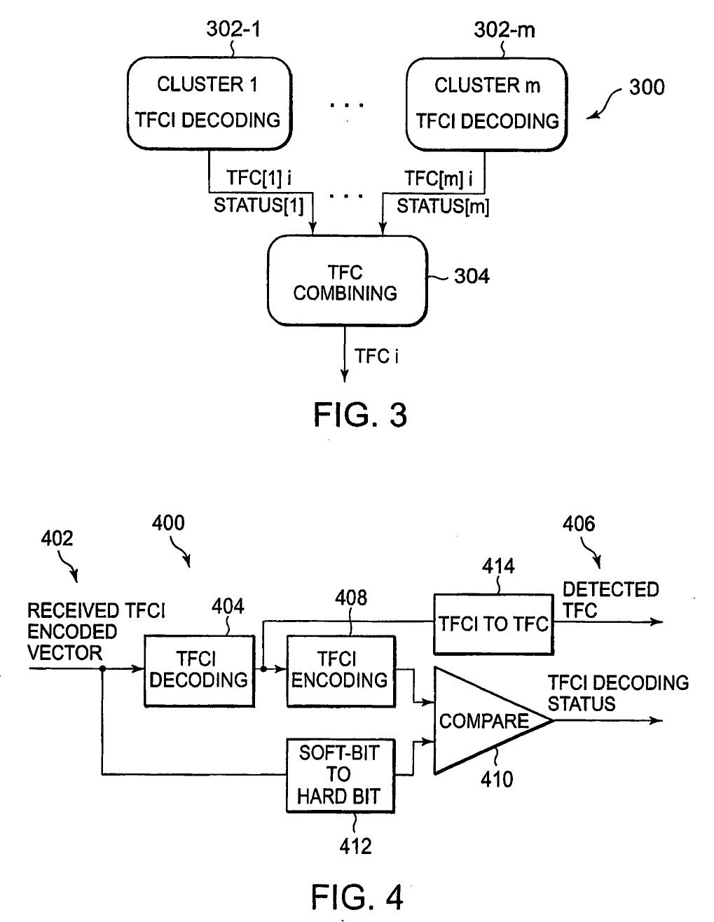

In embodiments of the present invention a transport format combining scheme can be used to determine or select the correct transport format to be used in subsequent processing after 208 soft combining. FIG. 3 illustrates an exemplary method for combining transport format data sets derived from different transmission clusters. The method 300 begins with the decoding of the TFCI symbols and determining a decoding status for each of the m S-CCPCH transmission clusters in steps 302-1 to 302-m. The group of m transport format vectors are then combined to form a single transport format combination (TFC) in TFC combining stage 304.

The TFC combining stage 304 can use a range of methods for combining the TFC data from the plurality of transmission clusters, including majority voting or selection based on the TFCI decoding status of each cluster. In embodiments that use a majority voting combining scheme, the majority voting can be biased towards a set of TF data in the scenario that a majority does not exist. Alternatively, in this situation a random section may be made.

FIG. 4 depicts a method of determining the TFCI decoding status that can be used in embodiments of the present invention. The method 400 begins by obtaining the received TFCI encoded vector for a particular cluster at 402. The encoded vector is then decoded at step 404 and the detected TFCI is converted to TFC in step 414. The TFCs from all clusters for soft combining are combined to produce a single TFC at 304 in FIG. 3. The received TFCI encoded vector is (optionally) converted from soft-bit into hard-bit at 412 if it is received in soft-bit format, otherwise, the 412 soft-bit to hard-bit is transparent. The decoded TFCI data from 404 is then encoded at 408 and then compared with the received encoded TFCI vector from 412 at 410 to produce a TFCI decoding status. Clearly if decoding is successful, the encoded TFCI data generated in step 408 should match the output from 412. Alternatively, if they are not the same, then decoding is unsuccessful.

Compared to other alternative soft combining schemes, embodiments of the present invention minimise processing power and buffer length requirements. Thus, the cost and power consumption of a user equipment using a scheme according to an embodiment of the present invention will be minimised.

For example, if soft combining is performed after transport channel de-multiplexing but before radio frame concatenation, the 2nd de-interleaving process, removal of the second discontinuous transmission indication and transport channel de-multiplexing will be duplicated for each S-CCPCH transmission cluster. Furthermore, the required buffer length for soft combining will be proportional to the maximum time difference among the S-CCPCH clusters rounded up to the number of frames.

In another example, if the soft combining is performed after radio frame concatenation but before channel decoding, the duplication of data processing among clusters is even greater than in the previous example. Moreover, the required buffer size for soft combining can potentially become proportional to the maximum time difference among the S-CCPCH clusters rounded up to the number of TTIs.

It will be understood that the invention disclosed and defined in this specification extends to all alternative combinations of two or more of the individual features mentioned or evident from the text or drawings. All of these different combinations constitute various alternative aspects of the invention.

It will also be understood that the term “comprises” (or its grammatical variants) as used in this specification is equivalent to the term “includes” and should not be taken as excluding the presence of other elements or features.

1. A method of conducting soft combining of at least two MBMS signals in a user equipment of a radio telecommunications network, the method including:
demodulating at least a subset of the received signals, and
soft combining at least a MBMS data field from two or more of the demodulated signals into a single MBMS data field prior to de-interleaving the MBMS data fields.

2. The method of claim 1 further including, extracting transport format data from one or more of the demodulated received signals.

3. The method of claim 2, further including: processing the transport format data extracted from one or more of the demodulated received signals to generate transport format data for use in subsequent processing of the soft combined MBMS data.

4. The method of claim 3, wherein processing the transport format data extracted from one or more of the demodulated received signals includes:
decoding a transport format data set for one or more of the demodulated received signals; and
generating a respective transport format decoding status data for each transport format data set.

5. The method of claim 4, wherein a transport format data set for use in further processing of the soft combined MBMS data is selected from one or more of the demodulated received signals at least partly on the basis of the signal's respective transport format decoding status data.

6. The method of claim 4, wherein a transport format data set for use in further processing of the soft combined MBMS data is generated using a majority voting scheme.

7. The method of claim 6, wherein the majority voting scheme is biased such that in the event that no majority exists a transport format data set can be obtained.

8. The method of claim 6, wherein the transport format data set is selected randomly from the decoded ones available.

9. The method of claim 1, wherein each of the received MBMS signals can include one or more signals received from corresponding nodes of a radio telecommunications network that forms part of a transmission cluster, configured to transmit MBMS data in a given time period.

10. A method of receiving an MBMS service in a user equipment of a radio telecommunications network, the method including soft combining at least two MBMS signals substantially in accordance with the method according to claim 1.

11. A user equipment for operating in a radio telecommunications network, wherein the user equipment is configured to soft combine at least two received MBMS signals in accordance the method of claim 1.

12. (canceled)

13. (canceled)

14. (canceled)

15. The method of claim 2, wherein each of the received MBMS signals can include one or more signals received from corresponding nodes of a radio telecommunications network that forms part of a transmission cluster, configured to transmit MBMS data in a given time period.

16. The method of claim 3, wherein each of the received MBMS signals can include one or more signals received from corresponding nodes of a radio telecommunications network that forms part of a transmission cluster, configured to transmit MBMS data in a given time period.

17. The method of claim 4, wherein each of the received MBMS signals can include one or more signals received from corresponding nodes of a radio telecommunications network that forms part of a transmission cluster, configured to transmit MBMS data in a given time period.

18. The method of claim 5, wherein each of the received MBMS signals can include one or more signals received from corresponding nodes of a radio telecommunications network that forms part of a transmission cluster, configured to transmit MBMS data in a given time period.

19. The method of claim 6, wherein each of the received MBMS signals can include one or more signals received from corresponding nodes of a radio telecommunications network that forms part of a transmission cluster, configured to transmit MBMS data in a given time period.

20. The method of claim 7, wherein each of the received MBMS signals can include one or more signals received from corresponding nodes of a radio telecommunications network that forms part of a transmission cluster, configured to transmit MBMS data in a given time period.
